(19) United States
(12) Patent Application Publication
(10) Pub. No.: US 2006/0238726 A1
(43) Pub. Date: Oct. 26, 2006

(54) Method for scanning and processing a negative film and apparatus using the same

(75) Inventor: Xian-Qiang Guo, SuZhou City (CN)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: BENQ Corporation

(21) Appl. No.: 11/269,090

(22) Filed: Nov. 8, 2005

(30) Foreign Application Priority Data
Apr. 25, 2005 (TW) 94113157

(51) Int. Cl. G03B 27/80

(52) U.S. Cl. 355/38

(57) ABSTRACT

A method for scanning and processing a negative film used in a scanner is disclosed. The method includes scanning the negative film to generate an original image; performing a calibration algorithm on the original image according to a calibration curve; and performing a negative algorithm on the calibration image by using negative characteristic parameters of the standard scanner to generate a final image.

This application claims the benefit of Taiwan application Serial No. 94113157, filed on Apr. 25, 2005, the subject matter of which is incorporated herein by reference.

### BACKGROUND OF THE INVENTION

1. Field of the Invention

The invention relates in general to a method for scanning and processing a negative film and apparatus using the same, and more particularly to a method for scanning and processing a negative film in which scan images are calibrated according to a predetermined calibration curve, and apparatus using the same.

2. Description of the Related Art

In digital image processing technology, color calibration is performed on reflective documents and positive films by using the corresponding Kodak IT8 cards. But there're no corresponding Kodak IT8 cards to do color calibration for negative films. Generally, a negative algorithm is used to eliminate the “color mask” existing in the negative film.

FIG. 1 is a diagram showing conventional procedures for digitally processing a negative film. Referring to FIG. 1, the negative film 100 is processed first in a scan procedure 110 to generate an original image 120. Next, a negative algorithm 140 is performed on the original image 120 according to negative characteristic parameters 130 generated beforehand to obtain a final image 150. The negative characteristic parameters 130 are characteristic values such as related to black and white calibration, Gamma regulation required in the negative digital processing. These characteristic values are highly related to hardware features and are not commutable in different types of scanners.

Due to large variations among negative films produced by different manufacturers, the negative films have no unified standards. The scanner has to repeatedly perform a cycle operation “regulate→inspect→regulate again→inspect again . . . ” so as to determine better negative characteristic parameters. Therefore, the scanner can scan different negative films to generate the corresponding final images closest to their original ones. In the process, a few tens of types of films in the market have to be inspected, and for each film, lots of types of images have to be tested, which requires large amount of work. The duration for adjusting the characteristic parameters generally lasts at least two weeks. The negative algorithm also has its application range and specific requirement on image data distribution (RGB brightness ratio) obtained by hardware. Moreover, the critical characteristic parameters are adjusted by hand and the image quality is difficult to demonstrate due to artificial decision. Especially, these negative characteristic parameters cannot completely remove variation factors existing in different types of scanners. Therefore, the same negative film will have different color display effects in different types of scanners, and an industrial standard is difficult to form.

### SUMMARY OF THE INVENTION

It is therefore an object of the invention to provide a method for scanning and processing a negative film and apparatus using the same. A calibration curve is generated according to the image data obtained from a standard calibration negative film as respectively scanned by a standard scanner and the scanner in usage, and is stored beforehand in a scanner's driver or firmware. The original images generated as scanning the to-be-scanned negative film are calibrated by the calibration curve to generate calibration images and a negative algorithm is performed on the calibration images by using the negative characteristic parameters of the standard scanner to obtain the final images. Consequently, not only research-and-development duration of the negative-film scanner can be reduced, but the quality of negative scan images can also be improved.

The invention achieves the above-identified object by providing a method for scanning and processing a negative film used in a scanner. The method includes scanning the negative film to generate an original image; performing a calibration algorithm on the original image according to a calibration curve, wherein the calibration curve is a mapping relation between a standard original image and a standard calibration image generated from a standard calibration negative film as scanned respectively by the scanner and a standard scanner; and performing a negative algorithm on the calibration image by using negative characteristic parameters of the standard scanner to generate a final image.

The invention achieves the above-identified object by providing an apparatus for scanning and processing a negative film including a scan unit, an image calibration unit, and a data processing unit. The scan unit is for scanning the negative film to generate original image data. The image calibration unit, connected to the scan unit, is for compensating the original image data and outputting calibration image data according to a calibration curve. The calibration curve is a mapping relation between standard original image data and standard calibration image data generated from a standard calibration negative film as scanned respectively by the scanner and a standard scanner. The data processing unit, connected to the image calibration unit, is for performing a negative algorithm on the calibration image data by using negative characteristic parameters of the standard scanner to generate final image data.

Other objects, features, and advantages of the invention will become apparent from the following detailed description of the preferred but non-limiting embodiments. The following description is made with reference to the accompanying drawings.

### BRIEF DESCRIPTION OF THE DRAWINGS

FIG. 1 is a diagram showing conventional procedures for digitally processing a negative film.

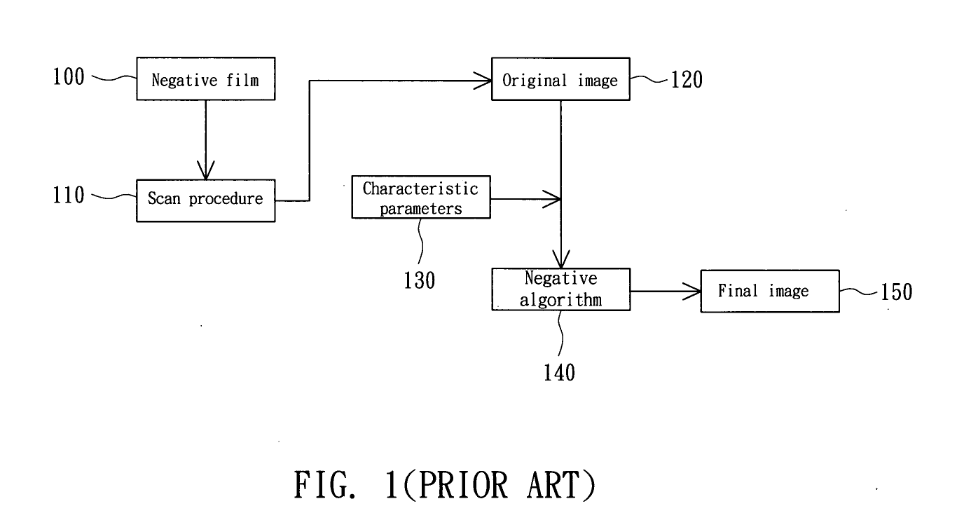

FIG. 2 is a block diagram of a negative scanning and processing apparatus according to a preferred embodiment of the invention.

FIG. 3A is a procedure diagram for forming the calibration curve according to the preferred embodiment of the invention.

FIG. 3B is a diagram of the calibration curve Lc according to the preferred embodiment of the invention.

FIG. 4 is a flow chart of the method for scanning and processing a negative film according to the preferred embodiment of the invention.

### DETAILED DESCRIPTION OF THE INVENTION

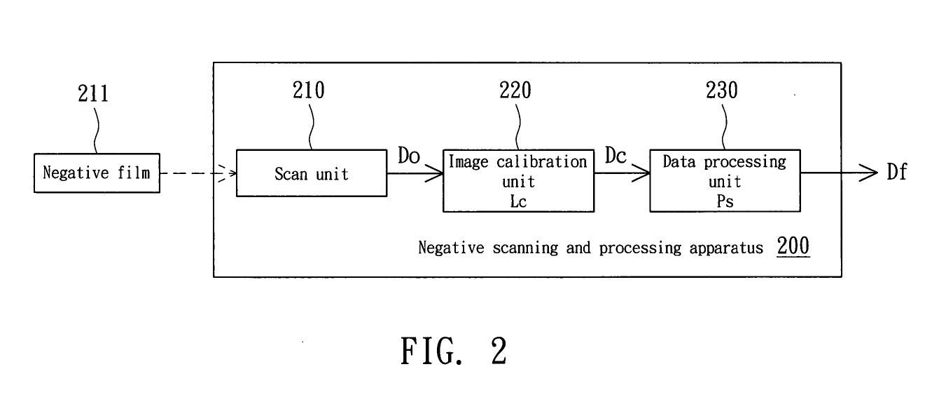

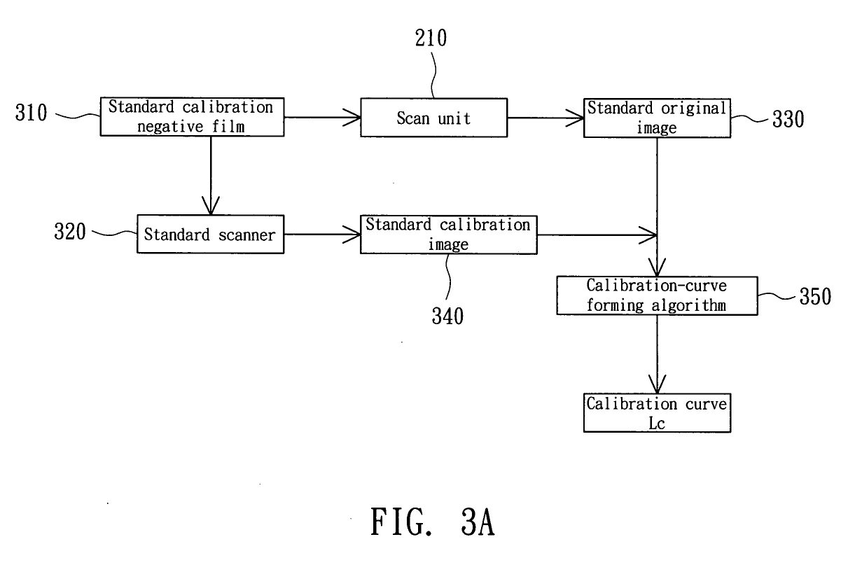

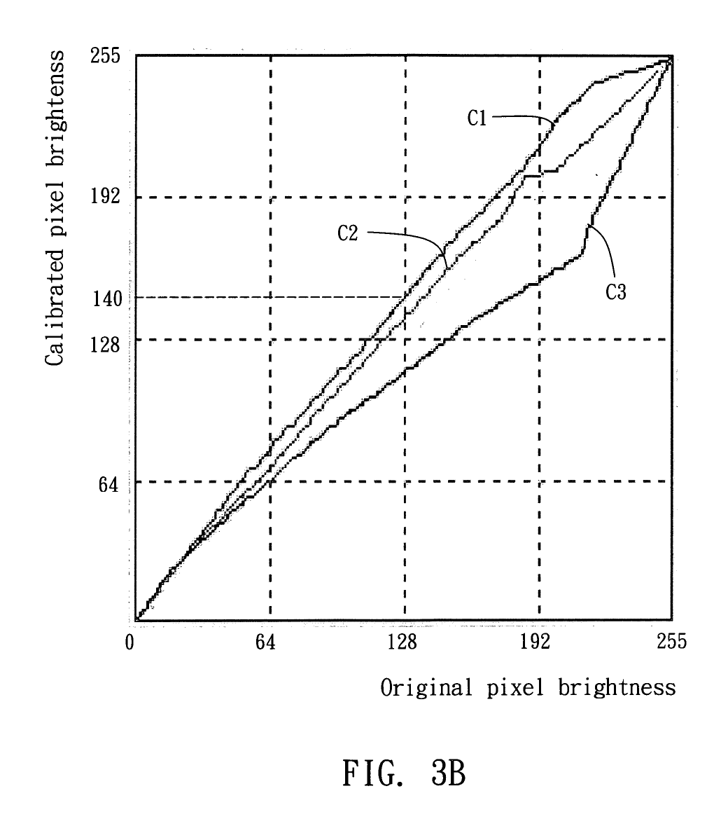

Refer to FIG. 2, FIG. 3A and FIG. 3B. FIG. 2 is a block diagram of an apparatus for scanning and processing a negative film according to a preferred embodiment of the invention. The apparatus 200 for scanning and processing a negative film includes a scan unit 210, an image calibration unit 220 and a data processing unit 230. The scan unit 210 is for scanning a negative film 211 and outputting original image data Do. The image calibration unit 220, connected to the scan unit 210, is for compensating the original image data Do to output calibrated image data Dc according to a predetermined calibration curve Lc. The data processing unit 230, connected to the image calibration unit 220, is for performing a negative algorithm on the calibrated image data Dc to output final image data Df by using characteristic parameters PS of a standard scanner.

The function of the scan unit 210 can be provided by a scanner while that of the image calibration unit 220 and the data processing unit 230 can be provided by a computer, or the function of the scan unit 210 and the image calibration unit 220 can be provided by a scanner while that of the data processing unit is provided by a computer, or the data processing unit 230 can be a scanner, or the function of the scan unit 210, the image calibration unit 220 and the data processing unit 230 can be also provided completely by a scanner.

Referring to FIG. 3A, a procedure diagram for forming the calibration curve according to the preferred embodiment of the invention is shown. The calibration curve Lc is a mapping relation between a standard original image 330 and a standard calibration image 340 generated from a standard calibration negative film as respectively scanned by the scan unit 210 and a standard scanner 320. First, determine a standard calibration negative film 310 and a standard scanner 320. The standard calibration negative film 310 is, for example, a negative film generated by photographing a reflective document of Kodak IT8 card or other substances with enough color variations on a film under a light source of constant luminance. The standard scanner 320 is a scanner having the best negative effect chosen from various types of scanners. Next, scan the standard calibration negative film 310 by the scan unit 210 to generate the standard original image 330. Afterward, scan the standard calibration negative film 310 by the standard scanner 320 to generate the standard calibration image 340. Perform a calibration-curve forming algorithm 350 on the standard original image 330 and the standard calibration image 340 to generate the required calibration curve Lc.

The above-mentioned calibration-curve forming algorithm 350 is a process of mapping the average brightness values of red/green/blue pixels in each color block of the standard original image 330 to the average brightness values of red/green/blue pixels in the corresponding color block of the standard calibration image 340. For example, the calibration curve Lc can be obtained by opening the standard original image 330 in photoshop software and carefully regulating the image 330 by using the curve regulation function until the image 330 is very close to the standard calibration image 340. Or the calibration-curve forming algorithm can also be performed by matlab software without using the photoshop software. Or the calibration-curve forming algorithm 350 can also be performed by a self-developed tool.

Referring to FIG. 3B, a diagram of the calibration curve Lc according to the preferred embodiment of the invention is shown. The calibration curve Lc generally includes three calibration curves respectively corresponding to red pixels, green pixels and blue pixels, as the curves C1, C2, and C3 shown in FIG. 3B. The transverse coordinate represents pixel brightness of the original image while the vertical coordinate represents pixel brightness of the calibration image. With regard to an 8-bit scanner, the pixel brightness of the curves C1, C2 and C3 has a range of 0˜255. Each calibration curve Lc includes a mapping relation between average brightness values {Rs1, Rs2, . . . , Rs264}, {Gs1, Gs2, . . . Gs264} and {Bs1, Bs2, . . . Bs264} of red/green/blue (RGB) pixels in each color block (264 color blocks for instance) of the standard original image 330 and average brightness values {Rs1′, Rs2′ . . . , Rs264′}, {Gs1′, Gs2′, . . . Gs264′} and {Bs1′, Bs2′, . . . Bs264′} of RGB pixels in the corresponding color block of the standard calibration image 340. The calibration curve C1 can be obtained by denoting the 264 points (Rs1, Rs1′), (Rs2, Rs2′), . . . , and (Rs264, Rs264′) in the coordinate frame, cutting off the points with the same transverse coordinate values and adding up the two terminal points (0,0) and (255, 255). The calibration curves C2 and C3 can be obtained by the same way. Usually, the duration for generating the calibration curves is only a few hours.

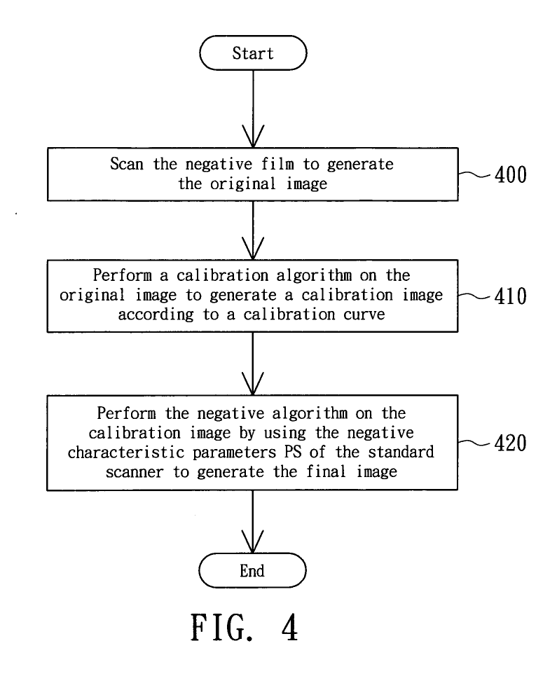

Referring to FIG. 4, a flow chart of the method for scanning and processing a negative film according to the preferred embodiment of the invention is shown. First, in step 400, scan the negative film 211 by the scan unit 210 to generate the original image Do. Next, in step 410, perform a calibration algorithm on the original image Do to generate a calibration image Dc according to the above-mentioned calibration curve Lc. Last, in step 420, perform the above-mentioned negative algorithm on the calibration image Dc by using the negative characteristic parameters Ps of the above-mentioned standard scanner 320 to generate the final image Df.

The above-mentioned calibration algorithm 430 is a process of mapping the RGB pixel brightness averages {Rs1, Rs2, . . . , Rs264}, {Gs1, Gs2, . . . Gs264} and {Bs1, Bs2, . . . Bs264} in 264 color blocks of the original image 420 via the calibration curve Lc to obtain the required calibrated pixel brightness averages as the RGB pixel brightness averages {Rs1′, Rs2′, . . . , Rs264′}, {Gs1′, Gs2′, . . . Gs264′} and {Bs1′, Bs2′, . . . Bs264′} in the corresponding color blocks of the calibration image 440. For example, R1=128, and the corresponding R1′, which is the required pixel brightness, is 140 as mapped by the calibration curve C1 of FIG. 3B. The calibration image Dc generated according to the calibration curve Lc is very close to the above-mentioned standard calibration image 340, and thus the final image Df with a good image quality can be generated as the above-mentioned negative algorithm is performed on the calibration image Dc according to the characteristic parameters Ps of the standard scanner 320. The negative characteristic parameters can even be slightly adjusted to obtain a better negative scan effect.

The method for scanning and processing a negative film and apparatus using the same according to the above-mentioned embodiment of the invention has the following advantages:

1. The invention can shorten the negative digital processing duration from two weeks to a few hours thereby effectively improving efficiency of negative scanning and processing research by using a calibration-curve forming algorithm instead of the conventional most time-consuming negative characteristic parameter adjusting procedure in the negative digital processing.

2. The negative processing method of the invention is not limited to the requirement of the hardware on the image data distribution for the conventional negative processing algorithm is not necessarily used. The negative effect variation among different types of scanners can be prevented and thus an industrial standard can be formed.

3. By choosing a better standard scanner, the negative scan image quality of the scanner having originally a poor image quality can also be improved, which is difficult to achieve by a conventional negative algorithm.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A method for scanning and processing a negative film, used in a scanner, comprising:
scanning the negative film to generate an original image;
performing a calibration algorithm on the original image according to a calibration curve, wherein the calibration curve is a mapping relation between a standard original image and a standard calibration image generated from a standard calibration negative film as scanned respectively by the scanner and a standard scanner; and
performing a negative algorithm on the calibration image by using negative characteristic parameters of the standard scanner to generate a final image.

2. The method according to claim 1, wherein the standard calibration negative film is generated by photographing a reflective document of Kodak IT8 card on a film under a light source of constant luminance.

3. The method according to claim 1, wherein the standard scanner is a scanner with the best negative effect chosen from various types of scanners.

4. The method according to claim 1, wherein the calibration curve is obtained by forming a mapping relation between average brightness values of red/green/blue pixels in each color block of the standard original image and average brightness values of the red/green/blue pixels in the corresponding color block of the standard calibration image.

5. The method according to claim 4, wherein the calibration curve can be formed by adjusting the standard original image via curve regulation function of photoshop software until the standard original image is very close to the standard calibration image.

6. The method according to claim 4, wherein the calibration curve can be formed by adjusting the standard original image via matlab software until the standard original image is very close to the standard calibration image.

7. The method according to claim 4, wherein the calibration curve can be formed by adjusting the standard original image via a self-developed tool until the standard original image is very close to the standard calibration image.

8. The method according to claim 1, wherein the calibration curve comprises a mapping relation between average brightness values of red/green/blue pixels in each color block of the standard original image and average brightness values of red/green/blue pixels in the corresponding color block of the standard calibration image.

9. The method according to claim 1, wherein the calibration algorithm maps average brightness values of red/green/blue pixels in each color block by using the calibration curve to obtain the average brightness values of red/green/blue pixels in the corresponding color block of the calibration image.

10. The method according to claim 1, wherein the calibration algorithm is performed in the scanner.

11. The method according to claim 1, wherein the calibration algorithm is performed by a computer connected to the scanner.

12. The method according to claim 1, wherein the negative algorithm is performed in the scanner.

13. The method according to claim 1, wherein the negative algorithm is performed by a computer connected to the scanner.

14. An apparatus for scanning and processing a negative film, comprising:
a scan unit, for scanning the negative film to generate original image data;
an image calibration unit, connected to the scan unit, for compensating the original image data and outputting calibration image data according to a calibration curve, wherein the calibration curve is a mapping relation between standard original image data and standard calibration image data generated from a standard calibration negative film as scanned respectively by the scanner and a standard scanner; and
a data processing unit, connected to the image calibration unit, for performing a negative algorithm on the calibration image data by using negative characteristic parameters of the standard scanner to generate final image data.

15. The apparatus according to claim 14, is a scanner.

16. The apparatus according to claim 14, wherein the data processing unit is a computer.

17. The apparatus according to claim 14, wherein the data processing unit is a scanner.

18. The apparatus according to claim 14, wherein the standard calibration negative film is a negative film generated by photographing a reflective document of Kodak IT8 card on a film under a light source of constant luminance.

19. The apparatus according to claim 14, wherein the standard scanner is a scanner with the best negative effect chosen from various types of scanners.

20. The apparatus according to claim 14, wherein the calibration curve comprises a mapping relation between average brightness values of red/green/blue pixels in each color block of the standard original image data and average brightness values of red/green/blue pixels in the corresponding color block of the standard calibration image data.
